(19) United States
(12) Patent Application Publication
(10) Pub. No.: US 2025/0074743 A1
(43) Pub. Date: Mar. 6, 2025

(54) Detection device for determining the floor

(71) Applicant: CEDES AG, Landquart (CH)

(72) Inventors: Andri von ALLMEN, Landquart (CH); Simon HARDI, Seewis-Schmitten (CH)

(21) Appl. No.: 18/818,841

(22) Filed: Aug. 29, 2024

(30) Foreign Application Priority Data
Sep. 1, 2023 (EP) 23194839.9

(51) Int. Cl. B66B 1/34; G01V 8/20

(52) U.S. Cl. CPC B66B 1/3492; G01V 8/20

(57) ABSTRACT

Detection device for a lift with a cabin with at least one cabin door, which is designed to carry out an opening movement and a closing movement when the cabin stops at a floor, to determine the floor when the lift cabin stops at a floor. The detection device has at least one accelerometer to detect the vibration of the cabin door during the opening movement and/or the closing movement. The detection device has an evaluation device, which is designed to create a vibration profile from the detection of the vibration during an opening movement and/or closing movement, and during a learning phase to create and store a reference vibration profile for each of at least two floors from one or more vibration profiles, and outside the learning phase to compare the currently recorded vibration profile with the existing reference vibration profiles, and to determine the reference vibration profile with the best match to the currently recorded vibration profile from the comparison, and to determine the relevant floor from this.

The detection device also has a light grid for detecting an object in the area of an open cabin door, which has a transmitter bar and a receiver bar, with at least one of the bars intended for mounting on the cabin door. Furthermore, the at least one accelerometer is arranged on the transmitter bar or receiver bar, which is intended to be attached to the cabin door.

### CROSS-REFERENCE TO RELATED APPLICATION

This application claims the benefit of European Application No. 23194839.9, filed Sep. 1, 2023.

### BRIEF DESCRIPTION OF THE DRAWINGS

Exemplary embodiments of the present disclosure are shown in the drawings and explained in more detail below. Identical reference signs in the individual figures designate corresponding elements. The figures show the following:

FIG. 1 show a two-leaf cabin and floor doors, in one example.

FIG. 2 show a cabin and floor door with coupling device, in one example.

FIG. 3 show a graphic of the distance measurement at the cabin door, in one example.

FIG. 4 show a vibration signatures of different floors, in one example.

### DETAILED DESCRIPTION

The present disclosure relates to a detection device for a lift to determine the floor when the lift cabin stops at a floor.

From prior art, detection devices are known that record a vibration profile of a lift door and compare it with existing vibration profiles assigned to a specific floor.

An object of the present disclosure is to provide an improved detection device of the above type.

This object is achieved, based on a detection device of the type mentioned at the beginning, by a detection device and a lift. Advantageous embodiments are discussed herein.

The detection device according to one example is a detection device for a lift with a cabin with at least one cabin door, which is designed to carry out an opening movement and a closing movement when the cabin stops at a floor, to determine the floor when the lift cabin stops at a floor. The detection device has at least one accelerometer to detect the vibration of the cabin door during the opening movement and/or the closing movement. The detection device has an evaluation device, which is designed to create a vibration profile from the detection of the vibration during an opening movement and/or closing movement, and during a learning phase to create and store a reference vibration profile for each of at least two floors from one or more vibration profiles, and outside the learning phase to compare the currently recorded vibration profile with the existing reference vibration profiles, and to determine the reference vibration profile with the best match to the currently recorded vibration profile from the comparison, and to determine the relevant floor from this.

The detection device further includes a status signal generator to output a signal for the start and/or end of the vibration detection, with the signal in particular not being derived from the vibration detection, and wherein the evaluation device is designed to infer the start and end of the detection from the signal.

The vibration profile is a characteristic from the measurement of the vibration during an opening and/or closing movement. The characteristic may be the time course of the acceleration, or a derived course or a derived status.

Best match can mean that a characteristic or part of the characteristic of a vibration profile deviates less from the characteristic or part of the characteristic of a reference vibration profile than other vibration profiles. Best match can also mean that a characteristic or part of the characteristic of a vibration profile deviates by less than a threshold from the corresponding characteristic or corresponding part of the characteristic of a reference vibration profile.

This can have the advantage that the vibration signature can be detected much more accurately. This can have the advantage of improving accuracy and reducing the effort required for analysis.

In one example, the detection device includes a light grid to detect an object in the area of an open cabin door, which has a transmitter bar and a receiver bar, with at least one of the strips intended to be attached to the cabin door. Furthermore, the at least one accelerometer is arranged on the transmitter bar or receiver bar, which is intended to be attached to the cabin door.

This can have the advantage that the detection device can be easily mounted along with the light grid. This can have the advantage that the accelerometer is always placed at a well-defined position along with the light grid. This can simplify and make the detection and determination of the floor more accurate.

In one example, the at least one accelerometer has a common carrier or a common housing with the transmitter bar and/or the receiver bar.

This can have the advantage that the detection device can be easily mounted along with the light grid. This can have the advantage that the accelerometer is always placed at a well-defined position along with the light grid. This can simplify and make the detection and determination of the floor more accurate.

In one example, the status signal generator is formed by the light grid and the evaluation device, wherein the light grid is designed to detect the distance between the transmitter bar and the receiver bar, in particular from the detection of the received intensity, and wherein the evaluation device is designed to determine the start and/or end time for vibration detection during the opening and/or closing movement from the detection of the distance, and in particular to associate it with a specific distance value.

This can have the advantage that the detection device can determine the start and/or end without external input. This can have the advantage of making the detection device work more reliably.

In one example, the status signal generator is designed to generate the signal for the start and/or end of the detection of the vibration during the opening and/or closing movement depending on a signal from the door control system.

This may have the advantage that the signal can be obtained very easily.

In one example, the at least one accelerometer is designed to detect the vibration of the floor door during the opening and/or closing movement. In one example, the at least one accelerometer is designed to detect the vibration in the direction of the opening and closing movement of the cabin door. In one example, the accelerometer is designed to detect the vibration in the direction perpendicular to the transmitter bar and/or receiver bar in the plane spanned by the transmitter and receiver bars. In one example, the accelerometer is arranged in the upper half, especially in the upper quarter, especially at the top end of the transmitter bar and/or receiver bar, in relation to the mounting position.

This can have the advantage of improving the signal-to-noise ratio and increasing reliability.

In one example, the detection device has two vibration sensors, wherein a first is attached to the transmitter bar and a second is attached to the receiver bar, both of which are intended for attachment to a cabin door.

The analysis of the measurements from the two vibration sensors can be performed separately for each sensor or by averaging the measurements of both sensors.

This may have the advantage that the operational reliability is increased.

In one example, the evaluation device is designed to create the vibration profile from an analysis of the time course of the vibration, in particular by a time-domain analysis, a frequency-domain analysis, and/or a sequence analysis. These analyses can form the derived status mentioned above.

This may have the advantage that the subsequent comparison to determine the floor can take place particularly reliably and/or faster.

In one example, the evaluation device is designed to create and store a reference vibration profile for each floor from one or more vibration profiles during the learning phase.

This can have the advantage that the detection device can be universally used in lifts.

The lift according to the invention is a lift with at least two floors with a detection device according to the invention as described above.

Further features of the invention are specified in the drawings.

The respective advantages mentioned can also be realized for combinations of features in which they are not mentioned.

FIG. 1 shows a lift cabin 20 at the landing position of a floor 10. The floor has two shaft doors 11. The cabin has two cabin doors 21. The shaft doors and cabin doors are designed as sliding doors. The cabin doors 21 can be motorized to move in the sliding direction for an opening or closing movement. In the landing position, the cabin doors 21 are each connected to the shaft doors 11 through a coupling device 30, so that when the cabin doors are motorized, the shaft doors perform the same movement. On the outside of the cabin door, a transmitter bar 41 and a receiver bar 43 of a light grid are flush mounted vertically to the edge of the cabin door facing the closing direction. The transmitter bar 41 and the receiver bar 43 each have an accelerometer 43 integrated into the housing with an evaluation device not shown. The accelerometer is located about 20 cm from the top end of each bar in the housing.

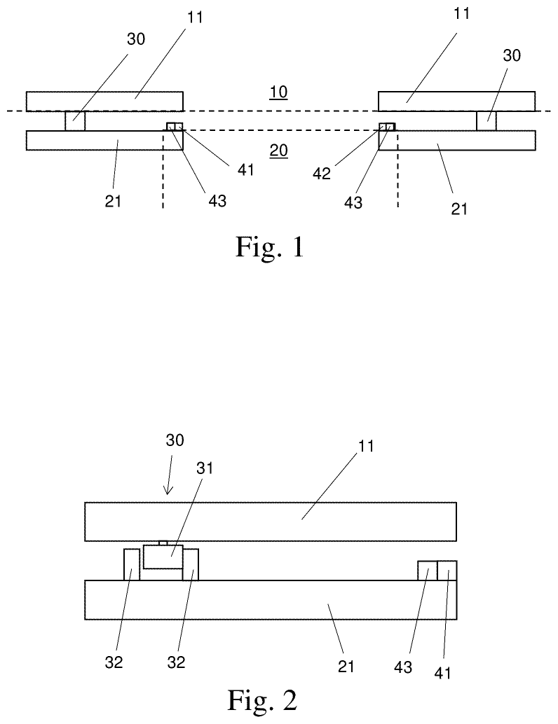

FIG. 2 shows in detail a cabin door 21 and a shaft door 11 connected by a coupling device 30. The coupling device has a roller 31, which is attached with its axis to the shaft door 11 and two drive blades 32, which are attached to the lift door. The drive blades are arranged so that they can move the roller in a horizontal direction in the landing position, so that the movement of the driven cabin door is transferred to the shaft door. Through the coupling device, vibrations are transferred from the shaft door to the cabin door.

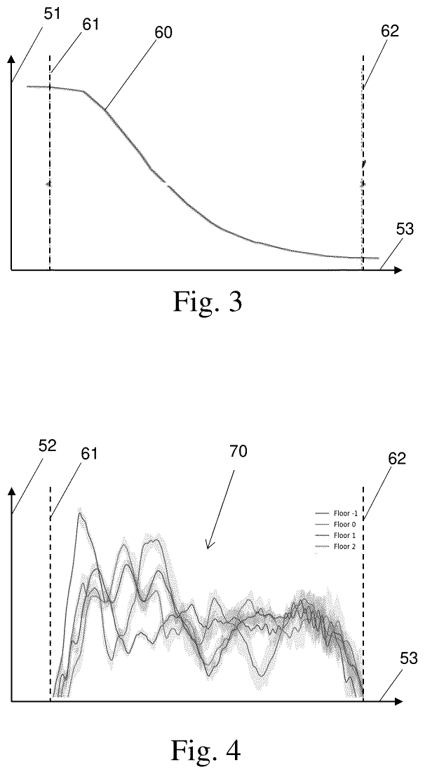

FIG. 3 shows a graph for distance measurement of the light grid at the cabin door during an opening movement. The vertical axis 51 shows the intensity. The horizontal axis 53 shows the time course. This is approximately proportional to the distance. The curve 60 shows the intensity detected by the receiver bar depending on the distance to the transmitter bar. This corresponds to the distance between the two cabin doors. The time point 61 corresponds to fully closed cabin doors at the start of the opening movement. The time point 62 corresponds to the end of the opening movement with fully opened cabin doors.

FIG. 4 shows a graph with five vibration signatures 70, which are assigned to different floors. The vertical axis 52 shows a measure for the vibration. The horizontal axis 53 shows the time course. The time points 61 and 62 for the start and end of the opening movement are taken from the measurement according to FIG. 3. The five vibration signatures 70 have a characteristically different course.

### LIST OF REFERENCE SIGNS

10 Floor
11 Floor door
20 Cabin
21 Cabin door
30 Drive device
31 Drive roller
32 Drive blades
41 Transmitter bar
42 Receiver bar
43 Accelerometer
51 Intensity
52 Vibration strength
53 Time
60 Time course of the distance
61 Start of an opening movement
62 End of an opening movement
70 Vibration signatures

1. A detection device for a lift with a cabin with at least one cabin door, which is configured to carry out an opening movement and a closing movement when the cabin stops at a floor, to determine the floor when the lift cabin stops at the floor, the detection device comprising:
at least one accelerometer configured to detect a vibration of the at least one cabin door during the opening movement and/or the closing movement; and
an evaluation device configured to:
create a recorded vibration profile from the detection of the vibration during the opening movement and/or the closing movement;
create and store one or more reference vibration profiles for each of at least two floors from one or more vibration profiles during a learning phase;
compare the recorded vibration profile with the one or more reference vibration profiles outside the learning phase;
determine a particular reference vibration profile, of the one or more reference vibration profiles, with the best as a match to the currently recorded vibration profile based on the comparison; and
determine the floor based on the particular reference vibration profile,
wherein the detection device has a status signal generator for outputting a signal for a start and/or end of vibration detection, wherein the signal is not obtained from the detection of the vibration, and wherein the evaluation device is configured to infer a start and an end of the detection from the signal.

2. The detection device according to claim 1, wherein the detection device has a light grid, for detecting an object in an area of an open cabin door and which has a transmitter bar and a receiver bar, with at least one bar, of the transmitter bar or the receiver bar, configured to mount on the cabin door, wherein the at least one accelerometer is arranged on the transmitter bar or the receiver bar.

3. The detection device according to claim 2, wherein the at least one accelerometer has a common carrier or a common housing with the transmitter bar and/or the receiver bar.

4. The detection device according to claim 2, wherein the status signal generator is formed by the light grid and the evaluation device, and the light grid is configured to detect a distance between the transmitter bar and the receiver bar, and the evaluation device is configured to determine the start and/or end for vibration detection during the opening movement and/or the closing movement from the detection of the distance.

5. The detection device according to claim 3, wherein the status signal generator is configured to generate the signal for the start and/or end of vibration detection during the opening movement and/or the closing movement depending on a signal from a door control system.

6. The detection device according to claim 2, wherein the at least one accelerometer is configured to detect the vibration of the cabin door during the opening movement and/or the closing movement.

7. The detection device according to claim 2, wherein the detection device has two vibration sensors, with a first attached to the transmitter bar and a second attached to the receiver bar, both configured for attachment to the cabin door.

8. The detection device according to claim 1, wherein the evaluation device is configured to create the recorded vibration profile from an analysis of a time course of the vibration.

9. The detection device according to claim 1, wherein the evaluation device is configured to create and store a reference vibration profile for each floor from one or more vibration profiles during the learning phase.

10. A lift with at least two floors with a detection device comprising:
at least one accelerometer configured to detect a vibration of at least one cabin door during an opening movement and/or a closing movement; and
an evaluation device configured to:
create a recorded vibration profile from the detection of the vibration during the opening movement and/or the closing movement;
create and store one or more reference vibration profiles for each of at least two floors from one or more vibration profiles during a learning phase;
compare the recorded vibration profile with the one or more reference vibration profiles outside the learning phase;
determine a particular reference vibration profile, of the one or more reference vibration profiles, as a match to the recorded vibration profile based on the comparison; and
determine the floor based on the particular reference vibration profile,
wherein the detection device has a status signal generator for outputting a signal for a start and/or an end of vibration detection, wherein the signal is not obtained from the detection of the vibration, and wherein the evaluation device is configured to infer a start and an end of the detection from the signal.

11. The detection device according to claim 4, wherein the light grid is configured to detect the distance between the transmitter bar and the receiver bar from the detection of a received intensity.

12. The detection device according to claim 4, wherein the evaluation device is configured to associate the start and/or end for vibration detection with a specific distance value.

13. The detection device according to claim 6, wherein the at least one accelerometer is configured to detect the vibration in a direction of the opening movement and the closing movement of the cabin door.

14. The detection device according to claim 6, wherein the at least one accelerometer is configured to detect the vibration in a direction perpendicular to the transmitter bar and/or the receiver bar in a plane spanned by the transmitter bar and receiver bar.

15. The detection device according to claim 6, wherein the at least one accelerometer is arranged in an upper half of the transmitter bar and/or the receiver bar, with respect to a mounting position.

16. The detection device according to claim 15, wherein the at least one accelerometer is arranged in an upper quarter of the transmitter bar and/or the receiver bar, with respect to a mounting position.

17. The detection device according to claim 15, wherein the at least one accelerometer is arranged at a top of the transmitter bar and/or the receiver bar, with respect to a mounting position.

18. The detection device according to claim 8, wherein the evaluation device is configured to create the recorded vibration profile by a time-domain analysis, a frequency-domain analysis, and/or a sequence analysis.

19. The detection device according to claim 1, wherein the one or more reference vibration profiles comprises a plurality of reference vibration profiles, and the evaluation device is configured to determine the particular reference vibration profile based on identifying which reference vibration profile, of the plurality of reference vibration profiles, deviates the least from a characteristic of the recorded vibration profile.

20. The detection device according to claim 1, wherein the evaluation device is configured to determine the particular reference vibration profile based on a determination that a characteristic of the recorded vibration profile deviates less than a threshold from a corresponding characteristic in the particular reference vibration profile.
